(19) United States
(12) Patent Application Publication
(10) Pub. No.: US 2019/0126708 A1
(43) Pub. Date: May 2, 2019

(54) Hydropneumatic Suspension Strut

(71) Applicant: ZF FRIEDRICHSHAFEN AG, Friedrichshafen (DE)

(72) Inventors: Nobert ACKERMANN, Eitorf (DE); Holger KIRCHNER, Ruppichteroth (DE)

(21) Appl. No.: 16/094,871

(22) PCT Filed: Mar. 23, 2017
(86) PCT No.: PCT/EP2017/056971

§ 371 Date: Oct. 18, 2018

(30) Foreign Application Priority Data
Apr. 22, 2016 (DE) 10 2016 206 891.1

(51) Int. Cl. B60G 15/06

(52) U.S. Cl. CPC B60G 15/062; B60G 2202/12; B60G 2206/73; B60G 2202/312; B60G 2202/24

(57) ABSTRACT

A hydropneumatic suspension strut includes a piston-cylinder unit with a first gas spring and a second carrying spring. The gas spring and the carrying spring are connected in parallel and have an identical working direction. The suspension strut is adjustable to at least two level positions. The second carrying spring has a spring rate that increases as the effective length of the suspension strut decreases.

### CROSS REFERENCE TO RELATED APPLICATION

This is a U.S. national stage of application No. PCT/EP2017/056971, filed on Mar. 23, 2017. Priority is claimed on German Application No. DE102016206891.1, filed Apr. 22, 2016, the content of which is incorporated here by reference.

### BACKGROUND OF THE INVENTION

### 1. Field of the Invention

The invention is directed to a hydropneumatic suspension strut.

### 2. Description of the Prior Art

DE 199 59 197 B4 describes a self-pumping hydropneumatic suspension strut that automatically controls a desired level position via an internal pump device. The suspension strut has a carrying force of a high-pressure gas cushion and a carrying force of a helical compression spring. Consequently, a piston-cylinder unit of the suspension strut with its gas carrying force is only dimensioned to be partially supporting.

When the vehicle and, therefore, the suspension strut has a greater load, the suspension strut sinks in temporarily but pumps automatically to the required level position again. When the load is reduced, the suspension strut lengthens and releases damping medium from a high-pressure region into a low-pressure region until the level position is also resumed again for this load. This mechanical solution for level adjustment affords the basic advantage of virtually constant resonant frequency.

Two arbitrarily adjustable level positions are also sometimes provided. It may be required, for example, that a vehicle is provided for both road operation and off-road operation. For this purpose, the unit in DE 199 59 197 B4 has an active actuating drive, which is functionally arranged in series with the suspension strut. This constructional form likewise has a constant resonant frequency, but in connection with the active actuating drive.

However, there are also self-pumping hydropneumatic suspension struts which can adjust two level positions but which do not have an active actuator. Reference is made to DE 10 2011 100 77267 A1, for example. A control sleeve inside the suspension strut can be adjusted with respect to its axial position relative to a regulating opening. In order to be able to approach a lower level position, the pressure level in the piston-cylinder unit in the high-pressure region must be reducible. This reduction takes place mechanically via the control sleeve. However, as a result of the reduced pressure level, the spring rate changes and, accordingly, the resonant frequency of the suspension strut changes.

### SUMMARY OF THE INVENTION

It is the object of the present invention to realize a hydropneumatic suspension strut that has at least two level positions and a resonant frequency as constant as possible.

According to one aspect of the invention a second carrying spring has a spring rate that increases as the effective length of the suspension strut decreases.

A carrying spring with a rising spring rate can have a progressive characteristic with a parabolic shape but can also have a plurality of characteristic regions with different slopes such that there are knees between the characteristic line regions. An aim of one aspect of the invention is to compensate a gas spring force reduced via a reduction in pressure through an increasing carrying force of the second carrying spring such that the resulting total carrying force of the two springs stays as constant as possible. The increase in force of the second carrying spring is achieved via a reduction in the effective length of the suspension strut. The reduction in the effective length does not present a drawback because the second level position is linked to a reduction in the effective length of the suspension strut.

It can be provided, for example, that the second carrying spring is constructed as a conical spring. This solution has the advantage of simplicity.

Alternatively, a helical compression spring having length areas with different wire diameters can also be provided as second carrying spring.

As further variants or in combination with one of the constructional forms described above, it can also be provided that the second carrying spring has at least two areas with a different slope of the coils. Because of the different slope, some spring coils already reach their solid length over the total spring deflection of the carrying spring and other coils still have a residual spring deflection. The quantity of springing coils is accordingly changed over the total travel. As a result, the total spring rate of the carrying spring also changes over the spring deflection.

A particularly large degree of design freedom for the carrying force characteristic of the second carrying spring is achieved in particular when the second carrying spring is formed by at least two individual carrying springs which are arranged in series and which have different effective solid lengths. The insertion points and, accordingly, the knees of the carrying force characteristic can be influenced via the effective solid length.

It can be provided that one of two individual carrying springs achieves the effective solid length via the abutment of the coils.

It can also be conceivable that an individual carrying spring is formed by an elastomeric body. In this regard, with a view to a uniform spring deflection it can be provided that the elastomeric body has a basic cell structure having walls which come into contact when there is maximum compression.

Further, there is the option that a blocking element determining a minimum effective length of the individual carrying springs is arranged between the two individual carrying springs. The advantage consists in that the mechanical solid length of the individual carrying springs which is frequently associated with stress peaks need not be utilized. An additional advantage consists in that the characteristic curve of the second carrying spring can be better defined through an adroit combination of the insertion point of the blocking element and of the spring rate of the individual carrying springs.

The blocking element can be formed, for example, by a profile component part which is supported at a spring plate of the suspension strut.

### BRIEF DESCRIPTION OF THE DRAWINGS

The invention will be described in more detail referring to the following description of the figures.

The drawings show:

FIG. 1 is a hydropneumatic suspension strut with a conical spring;

FIG. 2 is a spring rate characteristics for FIG. 1;

FIG. 3 is a hydropneumatic suspension strut with different wire diameters of the second carrying spring;

FIG. 4 is a hydropneumatic suspension strut with different slope of the second carrying spring;

FIG. 5 is a suspension strut with two individual carrying springs as second carrying spring; and

FIG. 6 is a suspension strut with a blocking element for the second carrying spring.

### DETAILED DESCRIPTION OF THE PRESENTLY PREFERRED EMBODIMENTS

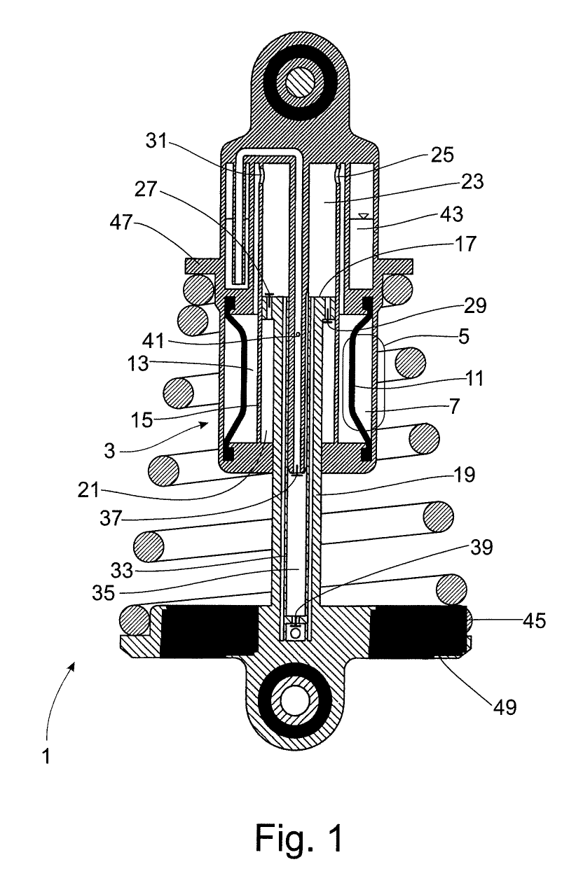

FIG. 1 shows a hydropneumatic suspension strut 1 with a piston-cylinder unit 3 that has a first gas spring 5 formed by a gas-filled annular space 7 inside of a cylinder 9. An annular diaphragm 11 separates the gas spring 5 from a high-pressure region 13 that is completely filled with a hydraulic working medium. A piston 17 is axially movably guided at a piston rod 19 inside of a pressure tube 15. The piston 17 divides the pressure tube 15 into a working chamber 21 on the piston rod side and a working chamber 23 remote of the piston rod. The two working chambers 21; 23 are connected to the high-pressure region 13 via at least one connection opening 25 and via piston valves 27; 29. An axially stationary pump rod 31 together with check valves 37; 39, a control sleeve 33 and a pump chamber 35 inside the piston rod form a pump which, depending on the axial position of the control sleeve 33 relative to a control opening 41 connecting a low-pressure region 43 to the high-pressure region 13, determines a first level position of a mass, e.g., a vehicle body, to be damped. A required level position can be adjusted without external energy via this pump through a relative movement of the piston rod 19 together with the control sleeve 33. The pressure within the high-pressure region 13 acts on the cross-sectional area of the piston rod 19 and accordingly exerts a moving-out force.

To move to a second level position, a second control opening formed at an axial distance from the first control opening 41 can be used for this purpose, for example. Alternatively, a control sleeve 33 which is axially displaceable relative to the piston rod would also be conceivable or, in a unit without a pump device, the pressure level of the gas spring 5 is simply changed. When the level position is lowered, the pressure level in the piston cylinder unit 3 is simply reduced regardless of how the pressure is generated, mechanical internal pumps or externally fed pumps. Accordingly, the carrying force of the gas spring 5 is reduced and a new equilibrium of forces is established between the carrying force of the hydropneumatic suspension strut 1 and a load.

A helical compression spring, as second carrying spring 45, is arranged functionally parallel to the gas spring 5. The second carrying spring 45 is supported via spring plates 47; 49 at the cylinder 9 and piston rod 19 and has the same working direction as the gas spring 5. The spring plates 45; 47 must in no case be fastened directly to the suspension strut 1. The spring plates 45; 47 can also be arranged at the load and at a supporting structure, e.g., a vehicle body as load and a chassis as supporting structure.

The position of the spring plates 45; 47 is not adjustable so that the second carrying spring 45 has an unalterable spring force characteristic.

The second carrying spring 45 is dimensioned in such a way that it has a spring rate that increases as the effective length of the suspension strut 1 is reduced. To this end, the second carrying spring is constructed as a conical spring in FIG. 1. The resonant frequency of the suspension strut depends on the sprung mass and spring rate of the carrying springs. If the pressure level in the high-pressure region 13 is lowered through an enlargement of the gas-filled annular space 7 or if the carrying capacity of the gas spring is reduced, the spring rate of the second carrying spring 45 which increases when the level position is lowered compensates for the reduced spring rate of the gas spring 5. Optimally, the opposing spring rates of gas spring 5 and second carrying spring 45 balance out so that the total spring rate is as constant as possible.

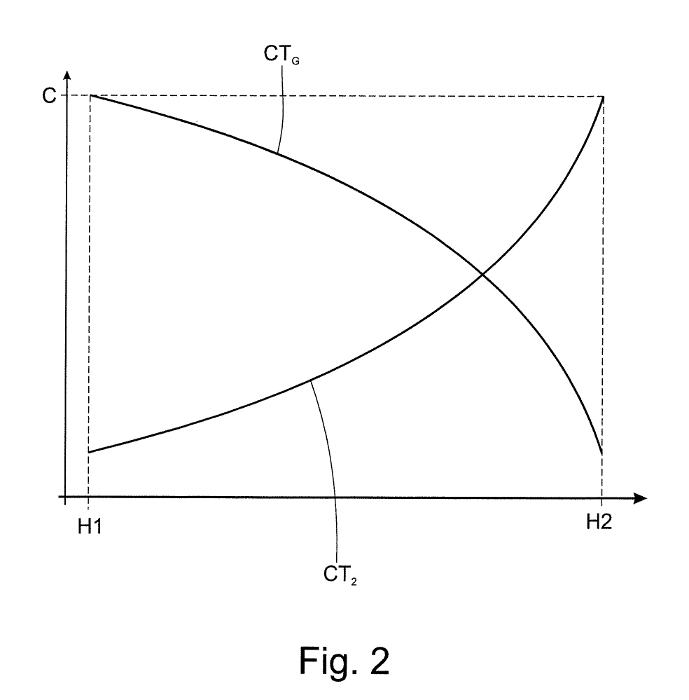

The technical relationship will be shown more clearly referring to FIG. 2. A section of the stroke path of the suspension strut 1 is shown on the ordinate. The characteristic line of the spring rate of the gas spring 5 is designated by CT_{G}, and the characteristic line of the second carrying spring 45 is designated by CT₂. A first level position with a greater extension length of the piston rod 19 is defined by point H1. In position H2, the piston rod 19 is moved appreciably deeper into the pressure tube. As can be seen from the drawing, the characteristic lines of the two carrying springs tend to run in opposite directions so that a substantially constant spring rate is achieved.

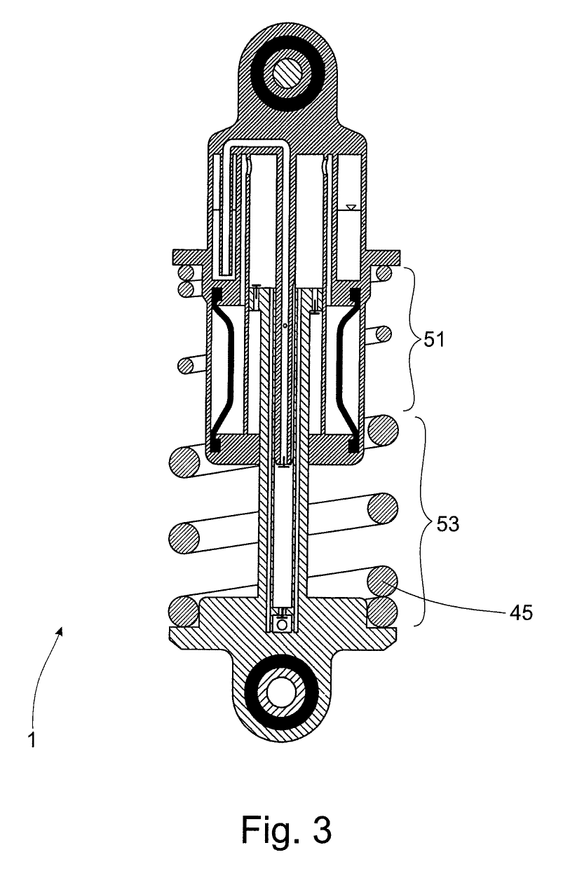

In the embodiment according to FIG. 3, a piston-cylinder unit 1 which has been modified over FIG. 1 is combined with a second carrying spring 45 having at least two areas 51; 53 with different wire diameters. A smaller wire diameter with the coil diameter otherwise remaining constant leads to a reduction in the spring rate in this area so that a spring characteristic comparable to that in FIG. 1 is achieved.

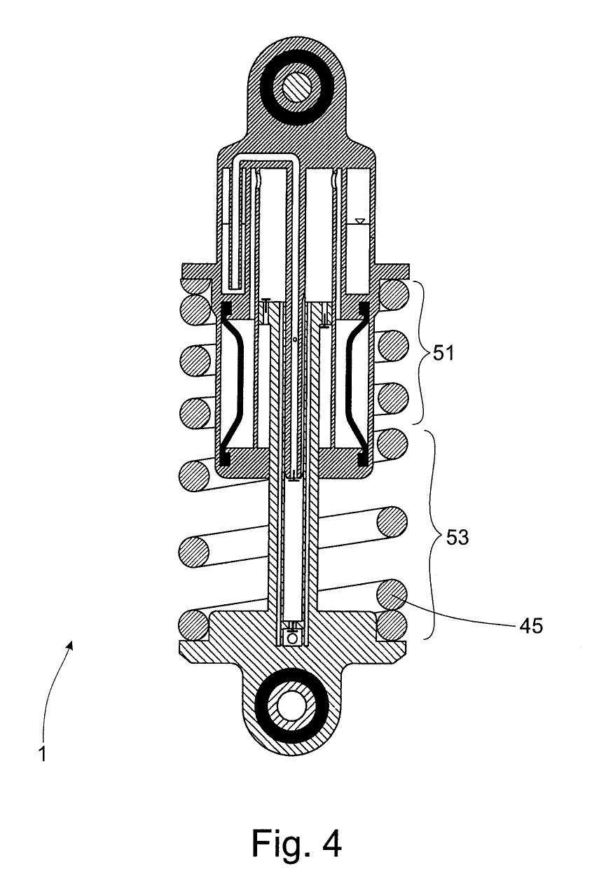

FIG. 4 shows a variant in which the second carrying spring 45 has at least two areas 51, 53 with a different slope of the spring coils. This construction also has a progressive spring characteristic.

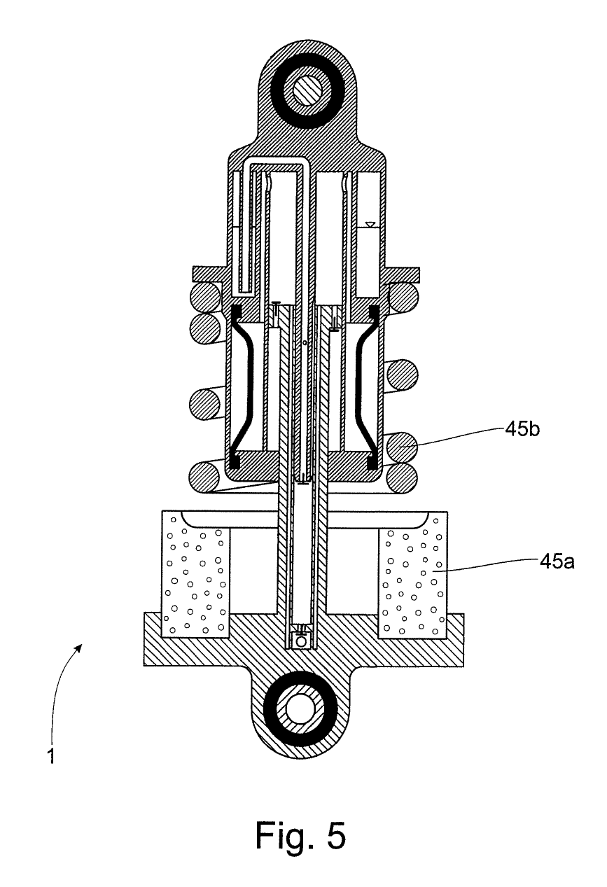

FIG. 5 shows an embodiment of the invention in which the second carrying springs 45 are formed by two individual carrying springs 45a; 45b, which are arranged in series and having different effective solid lengths and possibly different spring rates. When two individual springs are arranged in series, the total spring rate CT₂ is less than the individual spring rates CT₂₁; CT₂₂. Accordingly, a spring rate characteristic with a knee can be realized, e.g., through the selection of an effective solid length of one of the carrying springs 45a; 45b. The slope of the spring rate for the second carrying spring 45 increases at the knee. The effective solid length can be achieved in a helical compression spring via the abutment of the coils so that no residual spring deflection is available between the coils. Aside from a helical compression spring 45b, an individual carrying spring 45a constructed as an elastomeric body is proposed. This elastomeric body can have a cell structure, for example, with a smaller spring rate than the individual carrying spring constructed as helical compression spring 45b.

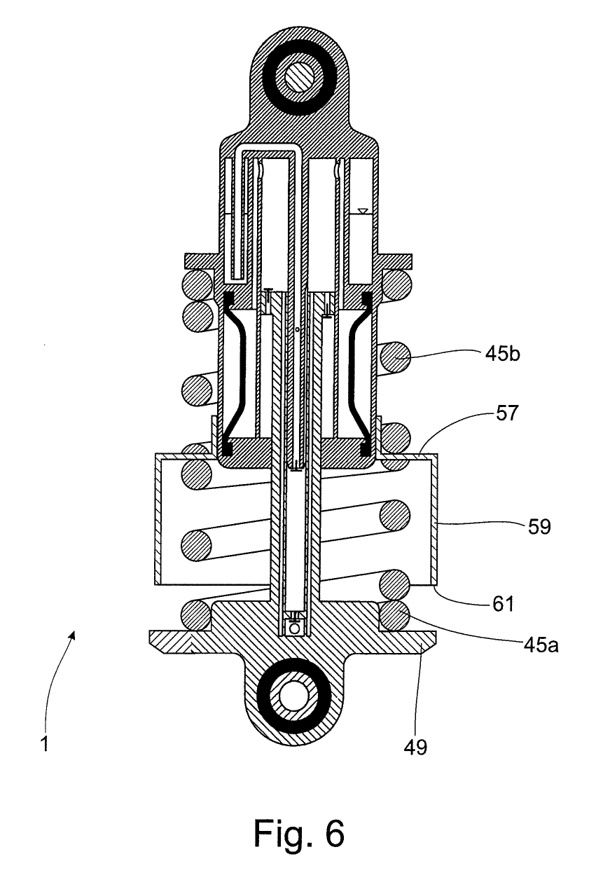

It will be seen from FIG. 6 that the effective solid length need not necessarily correspond to the mechanical solid length of the second carrying springs 45 in which the coils come into direct contact. To this end, the construction according to FIG. 6 has a blocking element arranged between the two individual carrying springs 45a; 45b. The constructional forms of the two individual carrying springs 45a; 45b have no relevance in this regard.

The blocking element has an intermediate plate area 57, and the two individual carrying springs 45a; 45b are supported at the two cover sides of this intermediate plate area 57. Further, the blocking element has a profile component part 59 formed by a sleeve in this embodiment example. The profile component part 59 has a stop surface 61 which defines a minimum distance between the spring plate 49 of individual carrying spring 45a and the intermediate plate area 57. The minimum distance is the effective solid length of the respective individual carrying spring 45a. As a result, the effective solid length and the actual solid length of the individual carrying spring 45a need not be identical.

When the blocking element comes in contact with the spring plate 49 and is accordingly active, the enclosed individual carrying spring 45a no longer participates in the further compression or the further increase in carrying force of the second individual carrying spring 45b. Consequently, it is practical for the blockable individual carrying spring 45a to have a smaller spring rate than the second individual carrying spring 45b that executes a spring motion in a permanent manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A hydropneumatic suspension strut comprising:
a piston-cylinder unit having a first gas spring;
a second carrying spring connected in parallel with the first gas spring and having an identical working direction as the first gas spring,
wherein the suspension strut is adjustable to at least two level positions, and
wherein the second carrying spring has a spring rate that increases as an effective length of the suspension strut decreases.

11. The suspension strut according to claim 10, wherein the second carrying spring is a conical spring.

12. The suspension strut according to claim 10, wherein the second carrying spring has areas with different wire diameters.

13. The suspension strut according to claim 10, wherein the second carrying spring has at least two areas with different coils slopes.

14. The suspension strut according to claim 10, wherein the second carrying spring is formed by two individual carrying springs that are arranged in series and which have different effective solid lengths.

15. The suspension strut according to claim 10, wherein the second carrying spring is formed by two individual carrying springs, and wherein one of the two individual carrying springs achieves the effective length via an abutment of coils.

16. The suspension strut according to claim 10, wherein an individual carrying spring is formed by an elastomeric body.

17. The suspension strut according to claim 14, wherein a blocking element determining a minimum effective length of an individual carrying spring is arranged between the two individual carrying springs.

18. The suspension strut according to claim 17, wherein the blocking element is formed by a profile component part supported at a spring plate of the suspension strut.
